(19) United States
(12) Patent Application Publication
(10) Pub. No.: US 2022/0268253 A1
(43) Pub. Date: Aug. 25, 2022

(54) ROTOR FOR A WIND TURBINE, WIND TURBINE AND ASSOCIATED METHOD

(71) Applicant: Wobben Properties GmbH, Aurich (DE)

(72) Inventors: Ralf Messing, Aurich (DE); Ellen Bauer, Aurich (DE); Florian Rubner, Aurich (DE)

(21) Appl. No.: 17/622,047

(22) PCT Filed: Jun. 25, 2020
(86) PCT No.: PCT/EP2020/067882

§ 371 Date: Dec. 22, 2021

(30) Foreign Application Priority Data
Jun. 27, 2019 (DE) 10 2019 117 365.5

(51) Int. Cl. F03D 1/06; F03D 7/02; F03D 7/04

(52) U.S. Cl. CPC F03D 1/0675; F03D 1/0641; F03D 7/0224; F03D 7/048; F05B 2270/32; F05B 2270/321; F05B 2270/328; F05B 2270/332; F05B 2240/3052; F05B 2260/96; F05B 2240/3042

(57) ABSTRACT

A rotor for a wind, to a wind turbine and to a method for increasing the yield of a rotor of a wind turbine. In particular, a rotor for a wind turbine, comprising at least one rotor blade, having a rotor blade trailing edge and rotor blade leading edge extending between the rotor blade root and the rotor blade tip over a rotor blade length, a profile depth established between the rotor blade leading edge and the rotor blade trailing edge, and an adjustable pitch angle, wherein the rotor blade has at least one profile element which is arranged on the rotor blade trailing edge or in the region adjacent to the rotor blade trailing edge for increasing the profile depth by an enlargement value, characterized by a control unit for determining a pitch angle to be set, which is configured to determine the pitch angle to be set depending on the enlargement value.

### BACKGROUND

### Technical Field

The invention relates to a rotor for a wind turbine, to a wind turbine and to a method for increasing the yield of a rotor of a wind turbine.

### Description of the Related Art

Wind turbines are fundamentally known, and they generate electrical power from wind. Modern wind turbines generally concern so-called horizontal-axis wind turbines, in the case of which the rotor axis is arranged substantially horizontally and the rotor blades sweep through a substantially vertical rotor area. Aside from a rotor arranged at a nacelle, wind turbines generally comprise a tower on which the nacelle with the rotor is arranged so as to be rotatable about a substantially vertically oriented axis. The rotor generally comprises one, two or more rotor blades of equal length.

By means of aeroacoustic effects, wind turbines emit noises that people can perceive. In the construction of wind turbines, in particular rotors and rotor blades, one aim of the construction is to achieve lower noise emissions. To reduce the noise emissions at a wind turbine, serrated trailing edges, so-called trailing edge serrations (TES), are often provided. A further aim in the construction of wind turbines is to increase the yield of the wind turbine.

The German Patent and Trademark Office has searched the following prior art in the priority application relating to the present application: DE 10 2008 016 007 A1, DE 10 2009 050 577 A1, DE 10 2015 113 404 A1, DE 10 2018 100 397 A1, US 2009/0 028 704 A1 and US 2013/0 115 082 A1.

### BRIEF SUMMARY

Provided is a rotor for a wind turbine, a wind turbine and a method for increasing the yield of a rotor of a wind turbine that reduce or eliminate one or more of the stated disadvantages. In particular, provided is a technique that increases the yield of a wind turbine.

According to a first aspect, provided is a rotor for a wind turbine, comprising at least one rotor blade, having a rotor blade trailing edge and rotor blade leading edge extending between the rotor blade root and the rotor blade tip over a rotor blade length, a profile depth established between the rotor blade leading edge and the rotor blade trailing edge, and an adjustable pitch angle, wherein the rotor blade has at least one profile element which is arranged on the rotor blade trailing edge or in the region adjacent to the rotor blade trailing edge for increasing the profile depth by an enlargement value, characterized by a controller for determining a pitch angle to be set, which is configured to determine the pitch angle to be set depending on the enlargement value.

The rotor comprises the at least one rotor blade. The rotor blade is preferably arranged with the rotor blade root on a hub of the rotor. The rotor blade root preferably faces the hub of the rotor. The rotor blade tip is preferably arranged facing away from the hub and/or an axis of rotation of the rotor.

The rotor blade extends from the rotor blade root to the rotor blade tip with a rotor blade length. The individual positions along the rotor blade between the rotor blade root and the rotor blade tip can also be specified in percent with the so-called relative rotor blade length. This position, indicated in percent, results from the ratio of the spacing of the position of the rotor blade root from the rotor blade length.

The rotor blade also has the rotor blade trailing edge and the rotor blade leading edge. During operation, the rotor blade leading edge faces the wind direction, that is, is oriented to the windward side. The rotor blade trailing edge preferably faces away from the wind during operation, that is, is oriented toward the leeward side. During operation, the wind thus first impinges on the rotor blade leading edge in order then to flow over the rotor blade profile toward the rotor blade trailing edge. The profile depth is established between the rotor blade leading edge and the rotor blade trailing edge. The profile depth is preferably determined in direct association between the rotor blade leading edge and the rotor blade trailing edge. The profile depth is preferably oriented substantially orthogonally to the direction of the rotor blade length and orthogonally to a thickness of the rotor blade.

The profile depth is increased by the enlargement value by the profile element. The rotor blade can thus have a modified profile depth, which is composed of the spacing of the rotor blade leading edge from the rotor blade trailing edge, namely the profile depth, and the enlargement value. The enlargement value is to be understood in particular as meaning the value of the projecting length of the profile element from the rotor blade trailing edge or from the region adjacent to the rotor blade trailing edge. In the profile section, the enlargement value is determined in particular by the distance of a root point of the profile element from a distal end of the profile element. The root point of the profile element is arranged in particular on the rotor blade trailing edge or in the region adjacent to the rotor blade trailing edge.

The rotor has an adjustable pitch angle. This means in particular that the rotor blade is arranged to be rotatable about a longitudinal axis during operation, the longitudinal axis being aligned between the rotor blade root and the rotor blade tip. This rotatable arrangement allows the angle of attack, and thus also the incident-flow angle, to be changed. As a result, the rotor blade can be used optimally in terms of its aerodynamic efficiency, depending on the wind speed. The rotor preferably comprises a hub, wherein the rotor blade is mounted on the hub in a rotational manner about its rotor blade longitudinal axis.

The rotor furthermore comprises the controller for determining a pitch angle to be set. The controller is configured to determine said pitch angle to be set depending on the enlargement value. The pitch angle to be set can depend on one, two or more parameters. In addition to the enlargement value, for example the wind speed and/or the nominal rotational speed and/or the electrical power of the rotor can be taken into account as parameters when determining the pitch angle to be set.

The inventors recognized that taking into account the enlargement value brought about by the profile element can be used to increase yield. When attaching profile elements, a multiplicity of parameters can have an influence on the aerodynamic profile coefficients, in particular the profile geometry itself, the angle of inclination of the profile element to the profile chord and the projecting length of the profile element.

The inventors have also found that, when using profile elements with an enlargement value that is 10% to 15% of the profile depth, the profile coefficients remain substantially unchanged if the increase in the profile depth because of the profile element is taken into account. The profile coefficients remain substantially identical over a large part of the linear branch of the profile polar. Only at high angles of attack, when the rotor blade profile approaches the region of flow separation, do the profile coefficients of the rotor blade with and without a profile element differ.

In particular, the inventors have found that, with the arrangement of profile elements, in particular serrated profile elements, in particular trailing edge serrations, the maximum angle of attack at which the flow separation begins is increased by an angular enlargement value. For example, this can be between 0.5 degree of arc and 1 degree of arc. The attachment of the profile element to the rotor blade trailing edge thus has a stabilizing effect on the flow around the profile, such that any flow separations occur only at a higher angle of attack. Owing to the arrangement of the profile element, which contributes to increasing the profile depth, the rotor blade also has an increased axial induction.

In addition to increasing the axial induction, the profile element also has an influence on the angle of attack applied locally on the rotor blade. Locally on the rotor blade means in particular that different angles of attack, which are influenced by the profile element, can be present at the different profile sections along the rotor blade length. The inventors have found that as the enlargement value becomes greater, the local angles of attack become smaller. It has also been recognized that the reduction in the local angle of attack can be established even in regions in which no profile element is arranged, for example in a region adjacent to a region with a profile element or the profile element which faces the hub.

The enlargement value of the profile element leads to there being angle-of-attack reserves. This means in particular that the maximum permissible angle of attack is increased, and smaller angles of attack can be provided in the region below the maximum permissible angle of attack, for example by setting the pitch angle accordingly, than would be the case in rotor blades without a profile element. In comparison to rotor blades without a profile element, by changing the local angle of attack by the profile element, it is possible, with the same wind speed, for the angle of attack to be changed. In particular, the pitch angle can be smaller.

The pitch angle can be selected to be smaller, the more the local angles of attack have been previously reduced by the enlargement value of the profile element. By reducing the pitch angle, the yields and loads on the system are increased. The controller for determining the pitch angle to be set, taking into account the enlargement value, leads to a yield-optimized wind turbine. The profile of the pitch angle over the wind speed can thus be adapted to the enlargement value.

An adjustable pitch angle means in particular that the rotor blade is movable rotationally about its longitudinal axis running from the rotor blade root to the rotor blade tip. The rotor preferably comprises at least one pitch adjustment motor for rotational adjustment of the rotor blade relative to the hub. The pitch adjustment motor preferably has an output shaft coupled to a pinion and the rotor blade has a toothing, these being arranged such that the pinion meshes with the toothing of the rotor blade.

The controller preferably has a storage unit (memory), wherein the enlargement value is stored in the storage unit. The controller is preferably configured to set the pitch angle of the rotor blade. Furthermore, the controller is preferably coupled to one, two or more pitch adjustment motors, the pitch adjustment motors being arranged and designed to set a pitch angle of the rotor blade. For this purpose, the pitch adjustment motors can be arranged, for example fixedly, on the hub of the rotor and can engage by means of a pinion in a toothing of the rotor blade. The rotor blade is preferably rotationally mounted on the hub, for example with a rolling bearing.

The controller can be coupled, for example, to the pitch adjustment motors for signaling purposes. The coupling for signaling purposes can be wired or wireless. The controller can also be coupled to a sensor system for signaling purposes. This sensor system can, for example, detect the wind direction and/or the wind speed and make it available to the controller, in particular by means of a wind signal. The wind signal is provided by the sensor system, that is to say in particular that it can be sent to the controller or the controller can access the wind signal.

The controller can be arranged inside the rotor, for example in the hub and/or in the rotor blade. In addition, the controller can be arranged remotely from the rotor, for example in a machine housing of a wind turbine or in a control system of a wind farm which preferably comprises two or more wind turbines.

In a preferred embodiment variant of the rotor, it is provided that the controller is configured to determine the pitch angle to be set depending on two or more enlargement values and/or on a profile of the enlargement value.

The enlargement value of the profile element can change along the rotor blade length. For example, the profile element can project at a first position along the rotor blade length with a first enlargement value and can project at a second position different from the first position with a second enlargement value. The first enlargement value is preferably different from the second enlargement value. In addition, the enlargement value can be different at different positions of the rotor blade length, such that a profile of the enlargement value is established. This profile of the enlargement value can be designed to be continuous and/or discontinuous.

According to a further preferred embodiment variant, it is provided that the controller is configured to determine the pitch angle to be set in indirect or direct dependence on the enlargement value.

There is a direct dependency on the enlargement value in particular when the controller uses the enlargement value to determine, in particular, to calculate the pitch angle to be set. There is an indirect dependency on the enlargement value, in particular, if, for example, a variable that is influenced by the enlargement value is used to determine the pitch angle to be set.

Furthermore, it is preferred that the controller is configured to determine the pitch angle to be set in indirect or direct dependence on the two or more enlargement values and/or on a profile of the enlargement value.

In a preferred development of the rotor, it is provided that the controller is configured to take into account an induction factor, a wind speed in the rotor blade plane, at least one local angle of attack and/or an air density when determining the pitch angle.

The controller can be designed as an independent controller of the rotor or as part of the system control of the wind turbine to which the rotor belongs. Functionalities of the controller can also be completely or partially removed from the rotor, for example can be implemented on a server.

The induction factor, the wind speed in the rotor blade plane and/or the at least one local angle of attack when determining the pitch angle are preferably taken into account when determining the pitch angle to be set in indirect dependence on the enlargement value. As already explained above, the enlargement value leads to a larger modified profile depth. A higher profile depth leads to a lower wind speed in the rotor blade plane, since the wind faces a higher resistance surface. A lower wind speed in the rotor blade plane leads by definition to a higher induction, since the induction factor a is determined by the following equation

$$a = 1 - \frac{{u}_{2}}{{u}_{1}} ,$$

wherein u₂ represents the wind speed in the rotor blade plane and u₁ represents the wind speed far in front of the rotor blade plane. With the same peripheral speed, the lower wind speed leads to a lower angle of attack. As a result, the induction factor, the wind speed in the rotor blade plane and the local angle of attack can be understood as indirect factors of the enlargement value.

According to a further preferred development of the rotor, it is provided that the rotor blade has a maximum angle of attack which is characterized by a substantially separation-free flow around the rotor blade, and the controller is configured to take into account the maximum angle of attack increased by the at least one profile element when determining the pitch angle to be set.

The substantially separation-free flow around the rotor blade can be determined in a polar diagram of the rotor blade, the lift coefficient being plotted against the angle of attack in the polar diagram. The maximum angle of attack at which there is still a substantially separation-free flow around the rotor blade can be read in the polar diagram where the lift coefficient reaches a global maximum. If the maximum angle of attack is exceeded, a flow separation occurs and the lift coefficient is reduced. As already explained above, the profile element can lead to an increase in the maximum angle of attack. The controller is preferably configured to take into account the increased maximum angle of attack when determining the pitch angle to be set.

According to a further preferred development of the rotor, it is provided that the controller is configured to control the pitch angle to be set in such a way that an angle-of-attack reserve of the rotor blade is set substantially independently of the enlargement value, wherein the angle-of-attack reserve is defined as the angle between a maximum angle of attack, which is characterized by a substantially separation-free flow around the rotor blade, and an angle of attack that is currently applied on the basis of the setting of the pitch angle.

It is further preferred that the controller is configured to set the pitch angle taking into account a maximum angle of attack, which is increased by the profile element, and/or an increased stall angle. In addition, it is preferred that the controller takes into account design loads of the wind turbine for determining the pitch angle, wherein the controller is preferably configured to compare operating loads of the wind turbine with the design loads.

The profile element and the enlargement value usually increase the loads on the rotor and, as a rule, also on other components of the wind turbine. These increased loads should not, or at least not too often, or not permanently, exceed the design loads of the wind turbine. By taking into account the design loads and the loads actually applied at the rotor, it is possible to reduce or eliminate exceeding the design loads, such that damage to the rotor and/or to the wind turbine can be avoided.

According to a further preferred development, it is provided that the enlargement value is less than or equal to 20%, preferably less than or equal to 15%, in particular less than or equal to 10%, of the profile depth. The profile depth established between the rotor blade leading edge and the rotor blade trailing edge can be, for example, 200 cm. In this example, if the enlargement value is 10% of the profile depth, the enlargement value is 20 cm. The projection length of the profile element is then, for example, 20 cm. If the enlargement value is selected to be 5%, the enlargement value would be 10 cm and the profile element would project by 10 cm.

In a further preferred development of the rotor, it is provided that the at least one profile element extends at least in sections over the rotor blade length.

Furthermore, it is preferred that the at least one profile element is arranged in a region of between 70% and 100% of a relative rotor blade length. Profile elements are arranged in particular in a region adjacent to the blade tip in order to reduce or eliminate noise emissions there. In particular, profile elements are arranged in a region of between 70% and 100% of the relative rotor blade length, which is thus adjacent to the rotor blade tip and extends, for example, with 30% of the rotor blade length in the direction of the rotor blade root.

Another preferred development of the rotor provides that a distal section of the at least one profile element has a serrated profile.

The profile element extends in the profile section preferably from a root end to a distal end. The root end is adjacent to the trailing edge or to a region adjacent to the trailing edge. The distal end is that end of the profile element which faces away from the trailing edge. The distal section is adjacent to the distal end. In this preferred embodiment variant, this distal section has a serrated profile. This serrated profile is characterized by low noise emissions.

According to a further preferred development of the rotor, it is provided that a distal section of the at least one profile element has a trapezoidal profile.

Another preferred embodiment variant provides that the profile element is adjustable such that at least a first enlargement value and a second enlargement value can be set, wherein the first enlargement value is smaller than the second enlargement value, and preferably the controller is configured to determine a smaller pitch angle when setting the second enlargement value than when setting the first enlargement value. Furthermore preferably, the controller is configured to determine and/or to set the pitch angle to be smaller, the greater the enlargement value.

According to a further aspect, provided is a wind turbine comprising a rotor according to one of the embodiment variants described above. The controller can be arranged in the rotor, in particular in a hub of the rotor. In addition, it may be preferred that the controller is arranged in a machine housing and/or in a tower of the wind turbine. In addition, the controller can also be arranged on other devices of the wind turbine. Furthermore, the controller can also be arranged outside the wind turbine, for example in a control system of a wind farm.

According to a further aspect, provided is a method for increasing the yield of a rotor of a wind turbine with an adjustable pitch angle, a rotor blade trailing edge and a rotor blade leading edge extending between the rotor blade root and the rotor blade tip over a rotor blade length, and a profile depth established between the rotor blade leading edge and the rotor blade trailing edge, wherein at least one profile element for increasing the profile depth by at least one enlargement value is arranged on the rotor blade trailing edge or in the region adjacent to the rotor blade trailing edge, characterized in that the pitch angle to be set is determined depending on the enlargement value.

The method and its possible developments have features or method steps which make them particularly suitable for being used for a rotor and its developments. For further advantages, embodiment variants and embodiment details of the wind turbine and of the method for increasing the yield and their respective possible developments, reference will also be made to the description given above concerning the corresponding features and developments of the rotor.

### BRIEF DESCRIPTION OF THE SEVERAL VIEWS OF THE DRAWINGS

Preferred exemplary embodiments will be explained by way of example on the basis of the appended figures. In the figures:

FIG. 1: shows a schematic view of a wind turbine;

FIG. 2: shows a schematic view of a rotor blade;

FIG. 3: shows a schematic view of a sub-section of a rotor blade trailing edge;

FIG. 4: shows a further schematic view of a sub-section of a rotor blade trailing edge;

FIG. 5: shows schematic partial views of profile elements;

FIG. 6: shows schematic profiles of axial induction factors;

FIG. 7: shows schematic profiles of angles of attack;

FIG. 8: shows schematically a flow diagram of a method.

In the figures, functionally identical or functionally similar elements are provided with the same reference signs.

### DETAILED DESCRIPTION

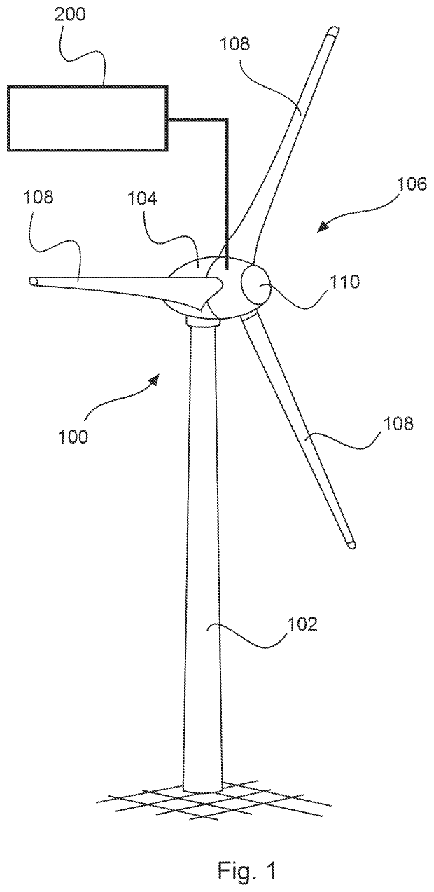

FIG. 1 shows a schematic illustration of a wind turbine. The wind turbine 100 has a tower 102 and a nacelle 104 on the tower 102. An aerodynamic rotor 106 having three rotor blades 108 and having a spinner 110 is provided on the nacelle 104. During the operation of the wind turbine 100, the aerodynamic rotor 106 is set in rotational motion by the wind and thereby also rotates an electrodynamic rotor or runner of a generator, which is coupled directly or indirectly to the aerodynamic rotor 106. The electric generator is arranged in the nacelle 104 and generates electrical energy.

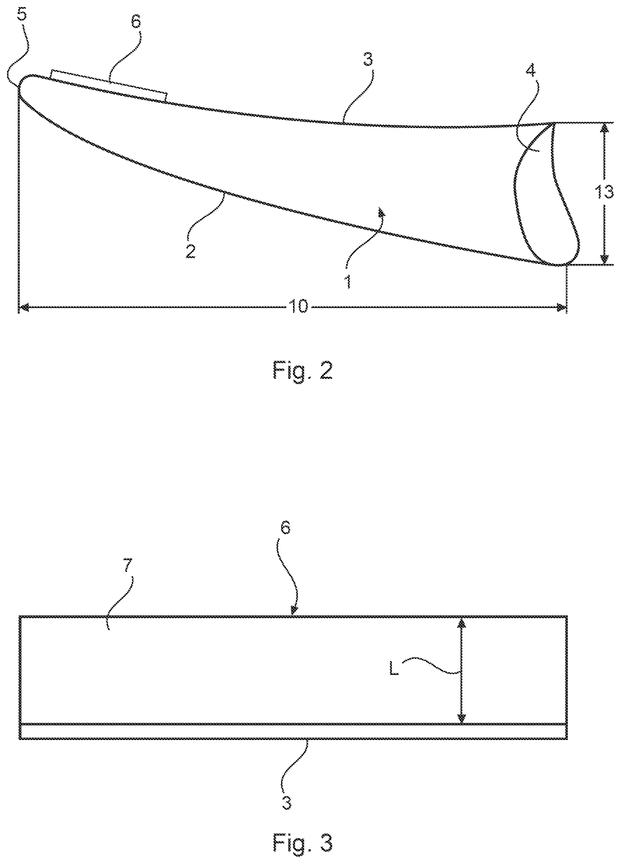

The pitch angles of the rotor blades 108 can be varied by way of pitch motors at the rotor blade root of the respective rotor blades 108. The rotor blades 108 each have a rotor blade root and a rotor blade tip, between which the rotor blades 108 extend with a rotor blade length. In addition, the rotor blades 108 each have a rotor blade trailing edge and/or a blade leading edge extending over the rotor blade length. A profile depth is established in each case between the rotor blade leading edge and the rotor blade trailing edge. To control the pitch angles of the rotor blades 108, a controller 200 is provided, which can be designed as a separate controller 200 of the pitch angle of the rotor blades 108 or as part of the control of the wind turbine 100. FIG. 2 shows a schematic view of a rotor blade 1, which is an example of one of the rotor blades 108 which are shown in FIG. 1. The rotor blade 1 extends from a rotor blade root 4 to a rotor blade tip 5, such that a rotor blade length 10 is established. The rotor blade 1 extends substantially orthogonally to the rotor blade length 10 from a rotor blade leading edge 2 to a rotor blade trailing edge 3. A profile depth 13 is established between the rotor blade leading edge 2 and the rotor blade trailing edge 3. A profile element 6, which projects from the rotor blade trailing edge 3, is arranged schematically on the rotor blade trailing edge 3.

FIG. 3 shows a schematic view of a sub-section of a rotor blade trailing edge 3. The profile element 6 is arranged at least in a sub-section of the rotor blade trailing edge 3. The profile element 6 shown has a continuous profile section 7. The profile element 6 projects from the rotor blade trailing edge 3. In the present case, the projecting length is the enlargement value L.

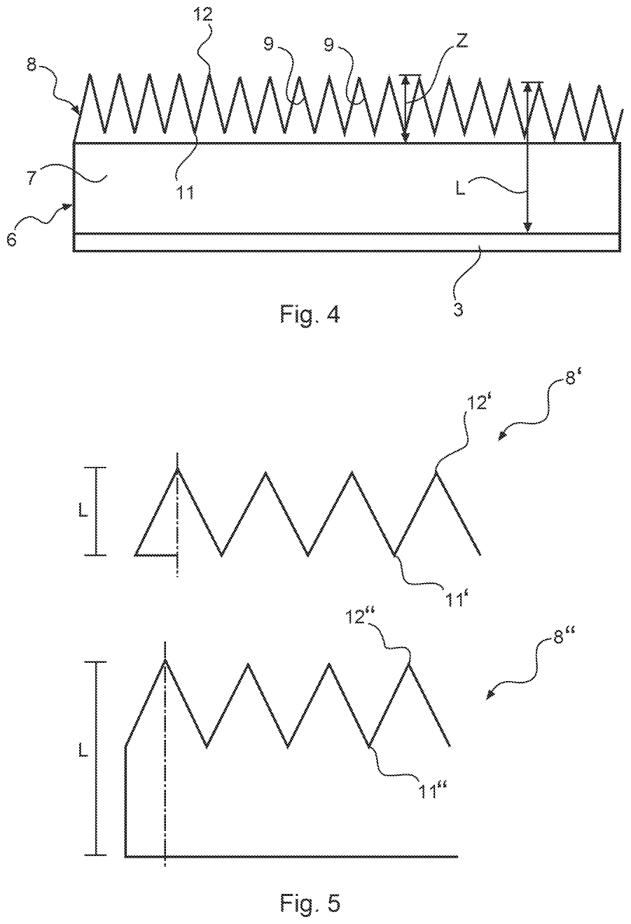

FIG. 4 shows a further schematic partial view of a rotor blade trailing edge. The profile element 6 shown here has, in addition to a continuous profile section 7, a serrated profile section 8. The enlargement value L is added up from the projecting length of the continuous profile section 7 and the projecting length of the serrated profile section 8, wherein the projection up to the serration tips 12 is taken into account. The serrations 9 of the serrated profile section 8 each have a serration base 11 and the serration tip 12 already mentioned above. A serration with a serration height Z extends between the serration base and the serration tip 12.

FIG. 5 shows schematic partial views of profile elements. The serrated profile section 8′ has serrations which extend from a serration base 11′ to a serration tip 12′. The serrated profile section 8′ has serrations arranged uniformly next to one another. The serrated profile section 8″ has pin-shaped serrations which are distinguished by a rectangular section and a serration-shaped section arranged thereon. The serrations have a serration base 11″ and a serration tip 12″.

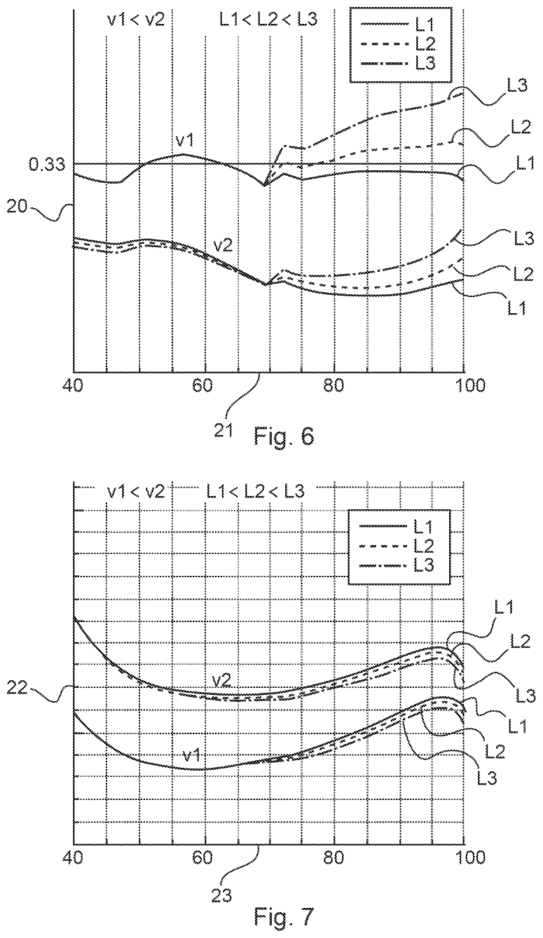

FIG. 6 shows schematic profiles of axial induction factors. The relative rotor blade length 21 is plotted on the abscissa. The axial induction factor 20 is plotted on the ordinate. The axial induction factor 0.33, which is also referred to as the Betz optimum, is entered as the constant. A total of six different curves are depicted in the diagram. Three curves are depicted for a first wind speed v1 and three further curves for a second wind speed v2. The first wind speed v1 is lower than the second wind speed v2.

For each wind speed, the axial induction factor applied at a relative rotor blade position in each case is plotted for in each case three different enlargement values. The induction factors along the rotor blade length are therefore plotted for two different wind speeds for a first profile element with an enlargement value L1, for a second profile element with an enlargement value L2 and for a third profile element with the enlargement value L3. In the diagram, the curves corresponding to the different enlargement values are denoted by L1, L2 and L3.

The profile elements are attached between 70% and 100% of the relative rotor blade length. It can be seen that, with a greater enlargement value, a greater axial induction or a higher axial induction factor 20 is achieved. In the case of the low wind speed v1, this leads to an overinduction in the case of an enlargement value L2 and L3. As a result, for example at the wind speed v1, the angle of attack for a profile element can be reduced with a first and second enlargement value, such that the Betz optimum at 0.33 can again be achieved.

FIG. 7 shows schematic profiles of angles of attack. The relative rotor blade length 23 is again plotted on the abscissa and the locally applied angle of attack 22 is plotted on the ordinate. It can be seen that, with increasing length of the profile elements, which is shown here by the enlargement values L1-L3, a lower local angle of attack is achieved. This is achieved by the fact that a longer profile element with a greater enlargement value achieves a greater reduction in the wind speed in the rotor plane, such that a smaller local angle of attack is set, taking into account the peripheral speed.

At the second wind speed v2, it can also be seen that the influence of the profile elements arranged between 70% and 100% also acts on the region in which no profile element is arranged, namely in the region between 40% and 70% of the relative rotor blade length.

The relationships between the induction and the enlargement value of the profile element that are shown here make it clear that it is desirable to take the enlargement value into account during the determination of an optimal pitch angle by the controller 200. As a result, the aerodynamic performance of the rotor can be improved, as can the yield of the wind turbine.

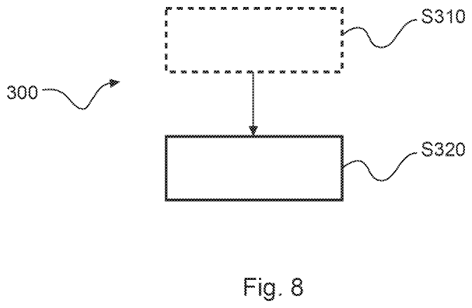

FIG. 8 schematically shows a flow diagram of a method 300 for increasing the yield of a rotor, for example the above-described rotor 106 of the wind turbine 100.

In a step S310, a profile element, for example a profile element 6 described above, is arranged to increase the profile depth by at least one enlargement value L. Step S310 is optional in the method 300 and may, for example, also already be carried out during the assembly of the wind turbine. Alternatively, the replacement of a profile element and the adjustment of the enlargement value L, for example in the context of maintenance of the wind turbine, are also described with this step.

In a step S320, the pitch angle to be set is determined depending on the enlargement value L of the profile element arranged in step S310. The regulation of the wind turbine in this way enables, as described, a yield-optimized operation of the wind turbine.

Furthermore, the method may include a step that comprises changing the enlargement value L during operation. The change in the enlargement value L can be made possible, for example, by a movable and/or extendable profile element. An actuator can be provided for this purpose.

### REFERENCE SIGNS

1 Rotor blade
2 Rotor blade leading edge
3 Rotor blade trailing edge
4 Rotor blade root
5 Rotor blade tip
6 Profile element
7 Continuous profile section
8 Serrated profile section
9 Serrations
10 Rotor blade length
11 Serration base
12 Serration tip
20 Axial induction factor
21, 23 Relative rotor blade length
22 Angle of attack
100 Wind turbine
102 Tower
104 Nacelle
106 Rotor
108 Rotor blades
110 Spinner
200 Controller
300 Method
S310 Arranging a profile element
S320 Determining the pitch angle
L Enlargement value
Z Serration height

1. A rotor for a wind turbine, the rotor comprising:
a rotor blade coupled to the rotor, the rotor blade having:
a rotor blade root and a rotor blade tip,
a rotor blade trailing edge and rotor blade leading edge extending between the rotor blade root and the rotor blade tip over a rotor blade length,
a profile depth between the rotor blade leading edge and the rotor blade trailing edge,
an adjustable pitch angle, and
a profile element arranged on the rotor blade trailing edge or in a region adjacent to the rotor blade trailing edge for increasing the profile depth by an enlargement value, and
a controller configured to determine a pitch angle in dependence on the enlargement value.

2. The rotor as claimed in claim 1, wherein the controller is configured to determine the pitch angle to be set depending on two or more enlargement values and/or on a profile of the enlargement value.

3. The rotor as claimed in claim 2, wherein the controller is configured to determine the pitch angle to be set in indirect or direct dependence on the enlargement value.

4. The rotor as claimed in claim 3, wherein the controller is configured to take into account an induction factor, a wind speed in a rotor blade plane, at least one local angle of attack, and/or an air density when determining the pitch angle.

5. The rotor as claimed in claim 1 wherein:
the rotor blade has a maximum angle of attack having a substantially separation-free flow around the rotor blade, and
the controller is configured to take into account the maximum angle of attack, which is increased by the profile element, when determining the pitch angle to be set.

6. The rotor as claimed in claim 1, wherein the controller is configured to control the pitch angle to be set in such a way that an angle-of-attack reserve of the rotor blade is set substantially independently of the enlargement value, wherein the angle-of-attack reserve is defined as an angle between a maximum angle of attack and an angle of attack that is currently applied based on the setting of the pitch angle, wherein the maximum angle of attack causes a substantially separation-free flow around the rotor blade.

7. The rotor as claimed in claim 6, wherein the controller is configured to set the pitch angle taking into account a maximum angle of attack, wherein the maximum angle of attack is increased by the profile element and/or an increased stall angle.

8. The rotor as claimed in claim 1, wherein the controller takes into account design loads of the wind turbine for determining the pitch angle, wherein the controller is configured to compare operating loads of the wind turbine with the design loads.

9. The rotor as claimed in claim 1, wherein the enlargement value is less than or equal to 20% of the profile depth.

10. The rotor as claimed in claim 1, wherein the profile element extends at least in sections over the rotor blade length.

11. The rotor as claimed in claim 1, wherein the profile element is arranged in a region of between 70% and 100% of a relative rotor blade length.

12. The rotor as claimed in claim 1, wherein a distal section of the at least one profile element has a serrated profile.

13. The rotor as claimed in claim 1, wherein a distal section of the at least one profile element has a trapezoidal profile.

14. The rotor as claimed in claim 1, wherein the profile element is adjustable such that a first enlargement value and a second enlargement value are configured to be set, wherein the first enlargement value is smaller than the second enlargement value, and wherein the controller is configured to determine a smaller pitch angle when setting the second enlargement value than when setting the first enlargement value.

15. A wind turbine comprising:
a tower, and
the rotor as claimed in claim 1 coupled to the tower.

16. A method comprising:
increasing a yield of a rotor of a wind turbine having an adjustable pitch angle, a rotor blade trailing edge, and a rotor blade leading edge extending between a rotor blade root and a rotor blade tip over a rotor blade length, and the rotor blade having a profile depth between the rotor blade leading edge and the rotor blade trailing edge, wherein increasing comprises:
arranging at least one profile element the rotor blade trailing edge or in a region adjacent to the rotor blade trailing edge, wherein the at least one profile element for increasing the profile depth by at least one enlargement value,
determining the pitch angle depending on the enlargement value, and
adjusting the pitch angle to the determined pitch angle.

17. The rotor as claimed in claim 11, wherein the enlargement value is less than or equal to 15% of the profile depth.

18. The rotor as claimed in claim 17, wherein the enlargement value is less than or equal to 10% of the profile depth.
